(19) United States
(12) Patent Application Publication
(10) Pub. No.: US 2007/0025224 A1
(43) Pub. Date: Feb. 1, 2007

(54) Optical disk drive

(76) Inventors: Yukiyasu Tatsuzawa, Yokohama-shi (JP); Hideyuki Yamakawa, Kawasaki-shi (JP); Koichi Otake, Yokohama-shi (JP); Toshihiko Kaneshige, Yokohama-shi (JP); Hiroaki Morino, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/493,831

(22) Filed: Jul. 27, 2006

(30) Foreign Application Priority Data
Jul. 29, 2005 (JP) 2005-220359

(51) Int. Cl. G11B 20/10

(52) U.S. Cl. 369/59.22

(57) ABSTRACT

According to one embodiment, a frequency detector detects a frequency error between a frequency of a reproduction signal supplied from an analog to digital converter and a frequency of a clock for conversion. A loop filter controls an oscillation frequency of a voltage control oscillator based on the frequency error and a phase error detected by a phase comparator. An adaptive equalizer equalizes a waveform of the reproduction signal supplied from the analog to digital converter to obtain a response of a predetermined PR class. A Viterbi decoder decodes the waveform equalized signal into binary data by maximum likelihood sequence estimation. A clock supply control circuit stops supply of a clock to at least the phase comparator, the adaptive equalizer and the Viterbi decoder in a case where the frequency error is larger than a designated error.

### CROSS-REFERENCE TO RELATED APPLICATIONS

This application is based upon and claims the benefit of priority from Japanese Patent Application No. 2005-220359, filed Jul. 29, 2005, the entire contents of which are incorporated herein by reference.

### BACKGROUND

1. Field

One embodiment of the invention relates to an optical disk drive which decodes data recorded in an optical disk, by use of partial response maximum likelihood (PRML) signal processing.

2. Description of the Related Art

Examples of a recording medium with respect to which digital data can be recorded and reproduced include an optical disk represented by a DVD. For example, in a DVD-RAM which is one of the DVDs, a signal recording layer is disposed, this signal recording layer is irradiated with laser light having appropriate energy to thereby change a crystalline state of the recording layer, and the digital data is recorded. When this recording layer is irradiated with the laser light having the appropriate energy again, it is possible to obtain an amount of reflected light in accordance with the crystalline state of the recording layer. This reflected light is detected to thereby reproduce the digital data.

In addition, in recent years, an PRML technology has been adopted in order to reproduce information recorded with a high density. Technical contents of the PRML technology are published in a document such as Jpn. Pat. Appln. KOKAI Publication No. 2001-195830. The contents of the technology will be described hereinafter.

A partial response (PR) is a method in which the data is reproduced by positively utilizing inter-code interference (interference between reproduction signals corresponding to bits recorded adjacent to each other), while compressing a necessary signal band. The method can further be classified into a plurality of types of classes in accordance with a way to generate the inter-code interference at this time. In, for example, class 1, reproduction data is reproduced as 2-bit data “11” with respect to the recording data “1”, and the inter-code interference is generated with respect to the subsequent one bit. The Viterbi decoding system (ML) is one type of so-called maximum likelihood sequence estimation. In the system, a rule of the inter-code interference of a reproduction waveform is effectively utilized in reproducing the data based on information of signal amplitude over a plurality of times. To perform this processing, a synchronous clock is generated in synchronization with the reproduction waveform obtained from the recording medium, the reproduction waveform itself is sampled by use of this clock, and the waveform is converted into amplitude information. Thereafter, the waveform is appropriately equalized to thereby convert the waveform into a predetermined partial response waveform. In the Viterbi decoder, the most likely data sequence (arrangement) is output as the reproduction data by use of past and present sample data. A system in which the above partial response system is combined with the Viterbi decoding (maximum likelihood decoding) system is referred to as the PRML system. To put this PRML technology to practical use, there are required: a high-precision adaptive equalization technology in which the reproduction signal is formed into a response of a targeted partial response (PR) class; and a high-precision clock reproduction technology which supports the adaptive equalization technology.

Next, there will be described a run length limiting code for use in the PRML technology. In the PRML reproduction circuit, the clock is generated from the signal itself reproduced from the recording medium, the clock being synchronized with the signal. To generate the stabilized clock, polarity of a recording signal needs to be reversed within a predetermined time. Moreover, the polarity of the recording signal is not reversed within a predetermined time in order to lower the maximum frequency of the recording signal. Here, the maximum data length with which the polarity of the recording signal does not reverse is referred to as the maximum run length, and the minimum data length with which the polarity does not reverse is referred to as the minimum run length. A modulation rule in which the maximum run length is eight bits and the minimum run length is two bits is called (1, 7) RLL, and a modulation rule in which the maximum run length is eight bits and the minimum run length is three bits is called (2, 7) RLL. Examples of a typical modulation and demodulation system for use in the optical disk include (1, 7) RLL and EFM Plus (see U.S. Pat. No. 5,696,505).

In the reproduction circuit in which the PRML technology is introduced in this manner, improvement of a reproduction performance is anticipated as compared with a conventional slice-type reproduction circuit. Especially, in recent years, there has been proposed an optical disk drive in which a large capacity is realized using blue purple laser. In an HD DVD as one of the disk drives, a linear recording density is raised by adopting this PRML technology, and further a data recording format is devised to realize the large capacity.

However, since a circuit scale enlarges owing to complexity of the constitution of the PRML signal processing circuit as compared with the conventional slice circuit, a way to reduce a power consumption during operation is a large technical problem.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing a constitution of a first embodiment in an PRML signal processing circuit in the present invention;

FIG. 2 is a block diagram showing a constitution of an adaptive equalizer;

FIG. 3 is an explanatory view showing an operation of the first embodiment;

FIG. 4 is a diagram showing a modification example of the first embodiment of the PRML signal processing circuit;

FIG. 5 is an explanatory view of an operation of a second embodiment of the present invention;

FIG. 6 is a diagram showing a constitution of the PRML signal processing in the second embodiment;

FIG. 7 is a diagram showing a constitution of the PRML signal processing circuit in a third embodiment of the present invention; and

FIG. 8 is an explanatory view of an operation of the third embodiment.

### DETAILED DESCRIPTION

Various embodiments according to the invention will be described hereinafter with reference to the accompanying drawings. In general, according to one embodiment of the invention, to achieve the problem, an optical disk drive of a first embodiment of the present invention is an optical disk drive which decodes data recorded in an optical disk by use of PRML signal processing, and includes: an optical pickup which irradiates the optical disk with laser light and which detects reflected light from the optical disk to supply a reproduction signal; an analog to digital converter which converts, into a digital value, a level of the reproduction signal supplied from the optical pickup; a voltage control oscillator which supplies a clock for conversion to the analog to digital converter; a frequency detector which detects a frequency error between a frequency of the reproduction signal supplied from the analog to digital converter and a frequency of the clock for conversion; a phase comparator which detects a phase error between an ideal sampling phase of the reproduction signal supplied from the analog to digital converter and a phase of the clock for conversion; a loop filter which controls an oscillation frequency of the voltage control oscillator based on the frequency error from the frequency detector and the phase error from the phase comparator; an adaptive equalizer which equalizes a waveform of the reproduction signal supplied from the analog to digital converter to obtain a waveform indicating a desired PR characteristic; a maximum likelihood decoder which converts, into reproduction data, a waveform equalization signal supplied from the adaptive equalizer by maximum likelihood decoding; and a clock supply control circuit which stops supply of a clock to at least the phase comparator, the adaptive equalizer and the maximum likelihood decoder, in a case where the frequency error is larger than a designated error.

In the PRML signal processing circuit which is essential for reproduction of an HD DVD, a small power consumption can be realized.

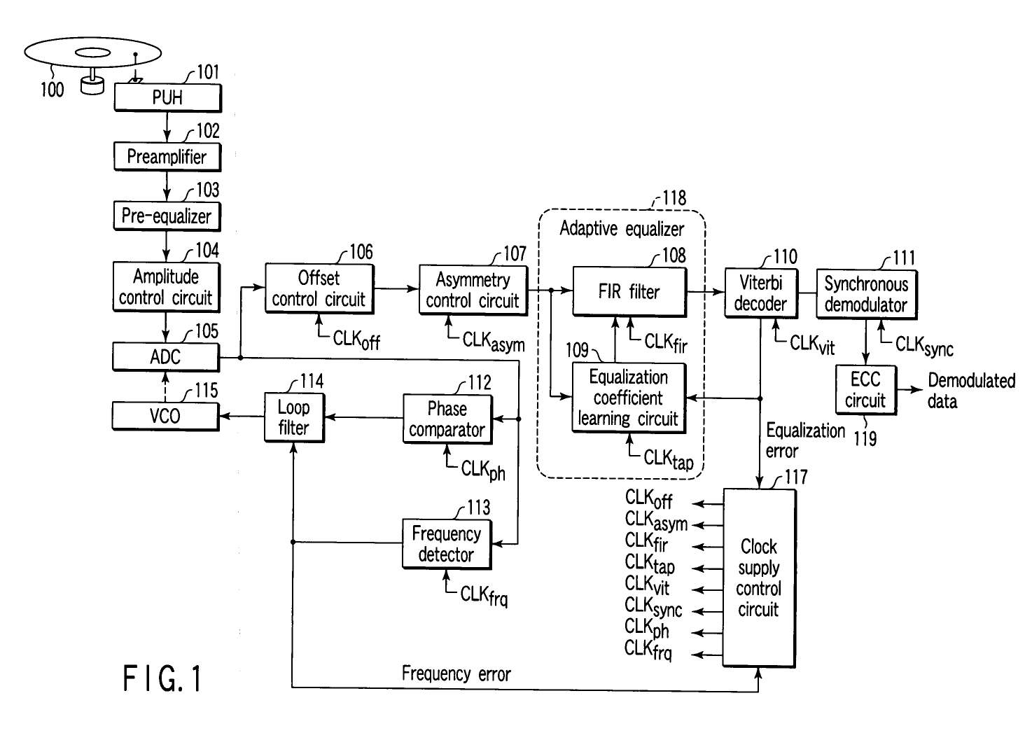

Specific embodiments of the present invention will be described hereinafter with reference to the drawings. FIG. 1 is a diagram showing a constitution of an PRML signal processing circuit in the present invention.

Reference numeral 100 denotes an operation disk medium. A pickup head (PUH) 101 irradiates the optical disk medium with appropriate laser light, and detects reflected light from the optical disk medium to thereby output a reproduction signal.

The reproduction signal output from the PUH 101 is sent to a preamplifier 102 and subjected to processing such as signal amplification. The signal is subjected to waveform equalization in advance by a pre-equalizer 103, an amplitude of the signal is adjusted by an amplitude control circuit 104, and an input signal level value is converted into a digital value by an analog to digital converter (ADC) 105.

At this time, a clock is extracted from a reproduction waveform itself to generate a conversion clock so that a sampling timing becomes appropriate. That is, a frequency detector 113 detects, from the reproduction waveform, the frequency error between the reproduction waveform and the signal frequency, a phase comparator 112 detects a phase error from an ideal sampling timing (sampling phase), and a sampling timing of the ADC 105 is controlled. This is a part generally referred to as a phase locked loop (PLL), and controlled by the same loop filter 114 together with a frequency control and a phase control, and the conversion clock is supplied by a voltage controlled oscillator (VCO) 115.

An output reproduction signal of the ADC 105 is subjected to digital waveform shaping by offset adjustment and asymmetry adjustment. An offset control circuit 106 processes an input signal so that offset of the reproduction signal input from the ADC 105 is eliminated. An asymmetry control circuit 107 processes an input signal to eliminate asymmetry from the reproduction signal input from the offset control circuit 106. The reproduction signal subjected to the digital waveform shaping is subjected to the waveform equalization in an adaptive equalizer 118 to obtain a response of a predetermined PR class such as PR (3443) which is a typical example. Adaptive learn processing is performed so that an equalization characteristic at this time becomes appropriate. Contents of specific constitutions of the adaptive equalizer and an adaptive learning section are disclosed in many documents such as Jpn. Pat. Appln. KOKAI Publication No. 2001-344903. The contents will be described later in detail.

When the signal having its waveform equalized into the predetermined PR class by the adaptive equalizer 118 is subjected to the maximum likelihood sequence estimation (Viterbi decoding) in a Viterbi decoder 110, binary data is obtained. Here, a recording data string is recorded as data every 1116 bits referred to as a frame. A synchronous demodulation circuit 111 detects a 24-bit binary data string (SYNC code) indicating a start position of each frame, and generates a synchronous signal every twelve bits for demodulation processing of the subsequent stage. The synchronous demodulation circuit 111 demodulates the binary data every twelve bits into eight-bit demodulated data in accordance with a predetermined rule, and further transmits the demodulated data to an error correction circuit (ECC circuit) 119. The ECC circuit 119 corrects errors added owing to defects or the like to thereby send data (corrected demodulated data) of the disk to a user side.

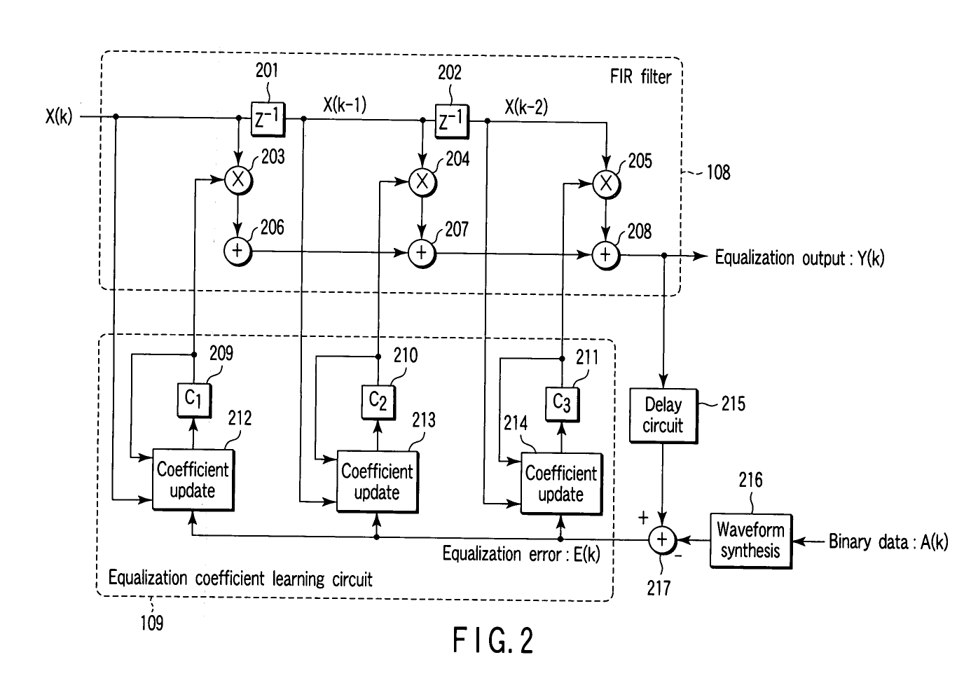

Next, there will be described the adaptive equalizer and a learning method of the equalizer with reference to FIG. 2. FIG. 2 is a block diagram showing details of the adaptive equalizer 118. The adaptive equalizer 118 is constituted of an FIR filter 108 and an equalization coefficient learning circuit 109. A delay circuit 215, a waveform synthesizer 216 and an adder 217 are processing circuits on the side of the Viterbi decoder 110, and generate an equalization error.

In this drawing, reference numerals 201, 202 denote delay circuits, and each circuit delays the input signal as much as one clock to output the signal. Reference numerals 203, 204 and 205 denote multiplication circuits, and each circuit outputs a product of two input values. Reference numerals 206, 207 and 208 denote addition circuits, and each circuit outputs a sum of two input values. FIG. 2 shows an example of a three-tap digital filter in which three multipliers are used. However, even if the number of the multipliers changes, a basic operation is the same. Here, there will be described the only three-tap digital filter.

Assuming that the input signal of the adaptive equalizer 118 at a time k is x(k), and multipliers to be input into the multipliers 203, 204 and 205 are c1, c2 and c3, respectively, an output Y(k) of the adaptive equalizer 118 can be represented by the following equation:
Y(k)=x(k)*c1+x(k−1)*c2+x(k−2)*c3 (1).

It is assumed that the binary data obtained in the Viterbi decoder 110 with respect to Y(k) is A(k). Assuming that a targeted PR class is, for example, PR(3 4 4 3), and A(k) is correct reproduction data, an original output Z(k) of the adaptive equalizer 118 at the time k is represented by the following equation:
Z(k)=3*A(k)+4*A(k−1)+4*A(k−2)+3*A(k−3)−7 (2).

In this case, an equalization error E(k) at the time k is defined by the following equation.
E(k)=Y(k)−Z(k) (3).

In adaptive learning, a coefficient (equalization coefficient) of each multiplier is updated in accordance with the following equations:
c1(k+1)=c1(k)−α*x(k)*E(k) (4);
c2(k+1)=c2(k)−α*x(k−1)*E(k) (5); and
c3(k+1)=c3(k)−α*x(k−2)*E(k) (6),
wherein α is an update coefficient, and set to a positive small value (e.g., 0.01).

Processing represented by the above equation (2) is performed by the waveform synthesizer 216. In this manner, the waveform synthesizer 216 supposes an inter-code interference at a time when data is recorded in the disk from the binary data (one-bit data) obtained in the Viterbi decoder 110, and outputs an ideal reproduction signal waveform as, for example, hexadecimal data (four-bit data).

The delay circuit 215 delays the output Y(k) of the addition circuit 208 as much as time corresponding to processing time in the Viterbi decoding circuit 110, and the addition circuit 217 performs processing represented by the above equation (3). A coefficient update circuit 212 performs calculation represented by the equation (4) to update the coefficient of the multiplier 203. An update result is stored in a register 209. A coefficient update circuit 213 performs calculation represented by the equation (5) to update the coefficient of the multiplier 204. An update result is stored in a register 210. A coefficient update circuit 214 performs calculation represented by the equation (6) to update the coefficient of the multiplier 205. An update result is stored in a register 211. As described above, the adaptive learning is performed in the adaptive equalizer 118.

Moreover, each control circuit of the PRML signal processing circuit which operates as described above is a synchronous circuit which operates in accordance with a sampling clock of the ADC 105. In the conventional technology, since the clock is constantly supplied to the PRML signal processing circuit during operation, much power has been consumed in a circuit constitution including many flip-flops. However, all the circuits do not have to operate in accordance with an operating situation. Therefore, in the present invention, the supply of the clock is controlled in an adaptive manner to thereby realize power saving. It is a clock supply control circuit 117 that controls the supply of the clock to each circuit in accordance with the operating situation. To the clock supply control circuit 117, there is transmitted an internal signal (frequency error, equalization error, etc.) by which an operating situation of each control circuit is known, and the clock supply control circuit 117 judges the operating situation from this internal signal to control supply and stop of the clock. All clock signals such as CLKoff and CLKasym to be supplied from the clock supply control circuit 117 to the circuit blocks are clocks generated by the VCO 115 or clock signals obtained by dividing the clocks. All of the signals are synchronized with the clock generated by the VCO 115.

There will be described hereinafter a method of supplying the clock in accordance with each operating situation.

(1) A sampling frequency control period in which a frequency error value is larger than a designated frequency error value:

In the sampling frequency control period in which the frequency error value detected by the frequency detector 113 is transmitted to the clock supply control circuit 117, and the frequency error value is larger than the designated frequency error value, the clock supply control circuit 117 stops supply of a clock CLKph of the phase comparator 112, and does not supply any signal to the loop filter. It is to be noted that in the frequency detector 113, the frequency is detected using a VFO region of the signal input from, for example, the ADC 105. In the VFO region, predetermined data having a single period is repeatedly recorded. When, for example, the period of this predetermined data is measured using a clock CLKfrq, the frequency of the input clock CLKfrq can be detected.

The designated frequency error value is calculated from a capture range of a phase control. If the frequency error value is not less than the designated frequency error value, it is judged that the signals cannot be in phase under the phase control, and the supply of the clock CLKph to the phase comparator is stopped to inhibit operation.

Moreover, since the reproduction signal does not have a normal signal waveform in such operating situation, there is stopped the supply of: a clock CLKoff to the offset control circuit 106 which is a waveform shaping circuit; a clock CLKasym to the asymmetry control circuit 107; a clock CLKfir to the FIR filter 108; and a clock CLKtap to the equalization coefficient learning circuit 109. Since the signal waveform does not have to be decoded or demodulated, there is stopped the supply of a clock CLKvit to the Viterbi decoder 110 and a clock CLKsync to the synchronous demodulator 111. Furthermore, the supply of a system clock to the ECC circuit 119 may be stopped.

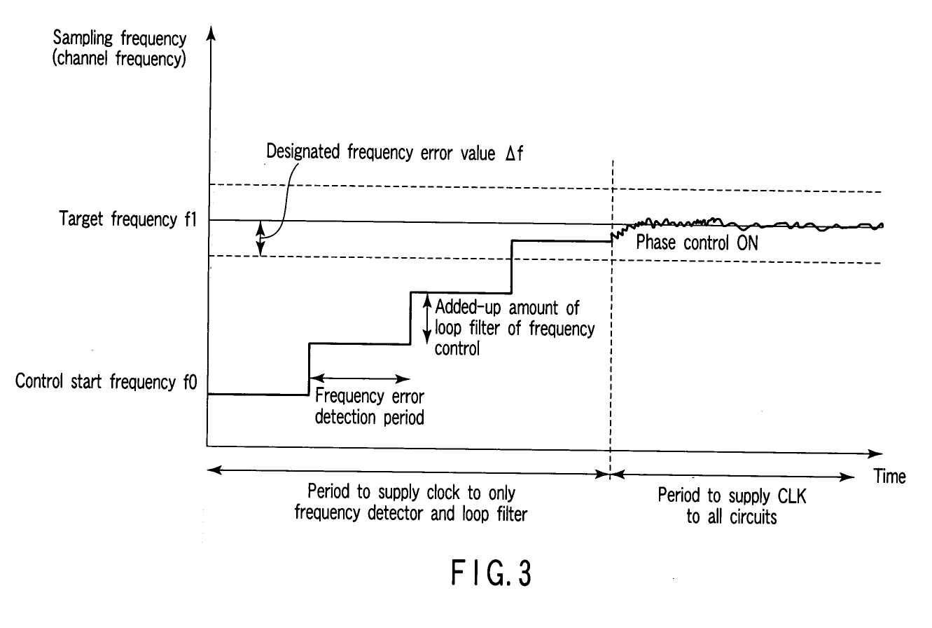

A sequence in this operating situation is shown in FIG. 3. Such operating situation is surely generated, when, for example, a track is sought. FIG. 3 is a diagram showing, in time series, a timing recovery operation (generation of a correct conversion clock) from a control start frequency f0 to a targeted channel frequency (target frequency) f1.

When the phase control is started sufficiently separately from the target frequency f1, a drift phenomenon of the phase control might be generated. Therefore, the VCO is driven under an only frequency control until the frequency sufficiently comes close to the target frequency (f1±Δf). That is, in this period, there is stopped the supply of the clock from the clock supply control circuit 117 to circuits other than the frequency detector 113 and the loop filter 114. Thereafter, when the frequency error value from the frequency detector 113 becomes smaller than the designated frequency error value Δf, the supply of the clock to all the circuits is started, and the phase is locked at the target frequency f1 by the phase control.

FIG. 3 shows timings as if the clocks were simultaneously restarted to be supplied to all of the circuits. However, it is effective to mutually delay and displace the restart timings with respect to the control circuits. In a case where the supplying is simultaneously restarted, data which is not expected might remain in a flip-flop of each control circuit. Therefore, there is a high possibility that shock is generated in the control. Moreover, learning conditions of the adaptive equalizer are premised on the phase locking. Therefore, it is more preferable that the learning start is delayed until the phase control is established, because a learning operation does not diverge. Such delay amount is a value to be determined by the constitution of the PRML signal processing circuit.

(2) In a case where a waveform shaping circuit is disposed along a path from the ADC 105 to the frequency detector 113:

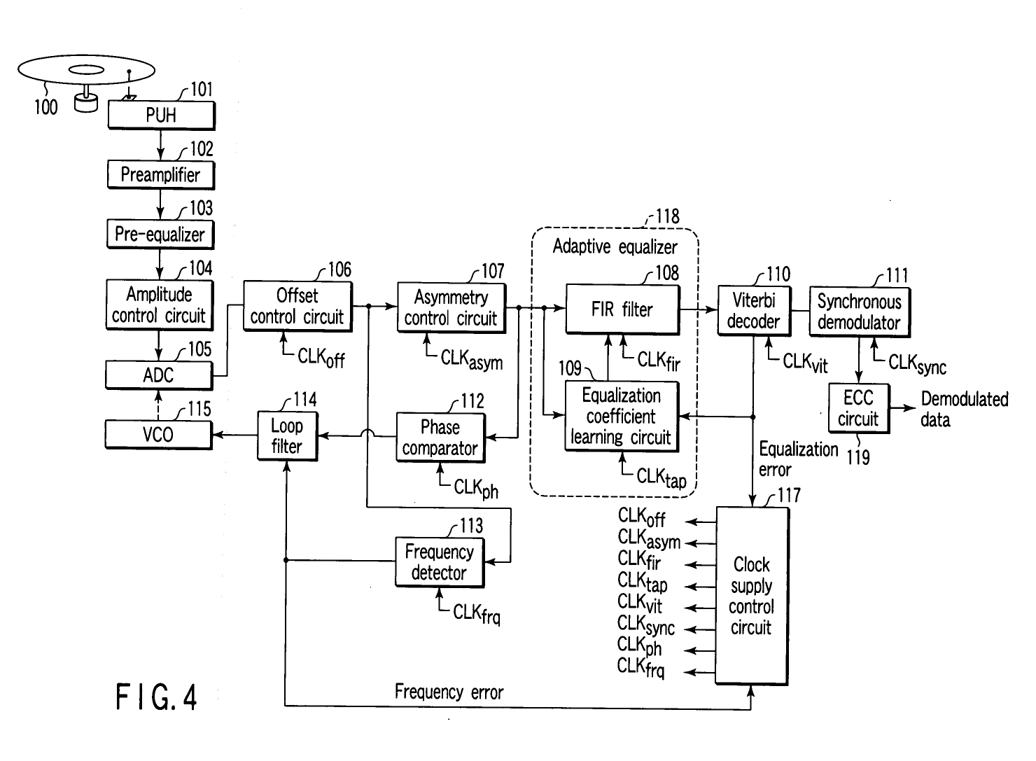

A signal processing circuit to which the clock supply method of the present invention is applied is not limited to the PRML signal processing circuit shown in FIG. 1. As shown in, for example, FIG. 4, the circuit may be constituted to perform timing recovery (detection of the frequency) by use of an output signal of the waveform shaping circuit (amplitude control circuit, offset control circuit, asymmetry control circuit or the like). In FIG. 4, the clock is constantly supplied to the offset control circuit 106 regardless of the above conditions, and the subsequent circuits 108 to 112 including the asymmetry control circuit 107 become objects of a clock supply control. Needless to say, the waveform shaping circuit is not limited to the shown circuit, and includes all circuits that shape the waveforms, such as the amplitude control circuit (AGC circuit) and the equalizer. That is, in a case where there are arranged a plurality of waveform shaping circuits which subject the output signal of the analog to digital converter 105 to waveform shaping for different purposes, when the frequency error is larger than the designated frequency error, the clock supply control circuit 117 stops the supply of the clock to the waveform shaping circuit which is not included in a signal path from the analog to digital converter 105 to the frequency detector 113 among a plurality of waveform shaping circuits.

(3) In a case where an evaluation index value generated by processing an equalization error value becomes smaller than a designated index value DI (signal quality level is high):

Next, there will be described a clock supply control in an adaptive equalizer 118 during steady reproduction in a second embodiment of the present invention.

As described above, the adaptive equalizer 118 produces an effect that the equalization error value is fed back to thereby bring an input signal to a PR characteristic, and an error ratio in a Viterbi decoder 110 is lowered. The adaptive equalizer 118 can especially compensate for frequency fluctuations or nonlinear distortions such as tangential tilts. However, in a state in which a signal quality level of the input signal is high, and an absolute value of an equalization error value is small, an equalization coefficient value of the adaptive equalizer 118 does not have to be updated. Even if an output is emitted by fixed equalization, an error ratio is not largely deteriorated.

A clock supply control circuit 117 obtains the equalization error value from the Viterbi decoder 110, and processes this equalization error value to generate an evaluation index value. In a case where the evaluation index value is smaller than a designated index value DI, it is judged that a signal quality level is high, there is stopped supply of a clock CLKtap to an equalization coefficient learning circuit 109, and the fixed equalization is performed with an equalization coefficient immediately before the supply of the clock is stopped. At this time, the supply of a clock CLKfir to an FIR filter 108 is not stopped.

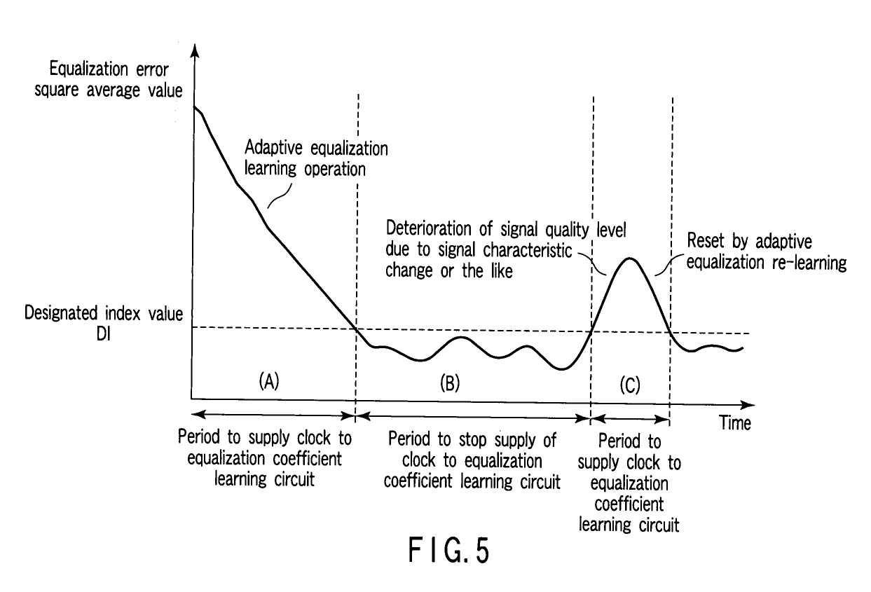

Here, there will be described a specific operation example in which the evaluation index value (hereinafter referred to as the equalization error square average value) is obtained by square-averaging the equalization error value with reference to FIG. 5. FIG. 5 is a diagram showing transition of the equalization error square average value after adaptive equalization learning starts. In FIG. 5, a segment (A) indicates a learning period immediately after the adaptive learning starts. In this state, the equalization error square average value is much deteriorated as compared with the designated index value DI. In this period, the clock CLKtap to the equalization coefficient learning circuit 109 is constantly supplied.

Next, in a segment (B) after a certain time, adaptive equalization is sufficiently performed. Since the equalization error square average value becomes smaller than the designated index value DI, the supply of the clock CLKtap is stopped. The fixed equalization is performed with a coefficient of the equalization coefficient learning circuit 109 in the last state of the segment (A). Considering from the circuit, the clock of the flip-flop is stopped, and an output of the flip-flop is fixed to a certain value.

The supply of the clock may be kept to be stopped in a state in which the quality level of the signal is high. However, in the optical disk, when the equal equalization coefficient is used, the equalization error value is sometimes deteriorated owing to a plurality of factors such as a difference of the signal characteristic in a recording face and the presence of defects. A segment (C) indicates this case. When the equalization error square average value is larger than the designated index value DI, the supply of the clock CLKtap is restarted, the learning is again performed, and the equalization error value is controlled to be reduced.

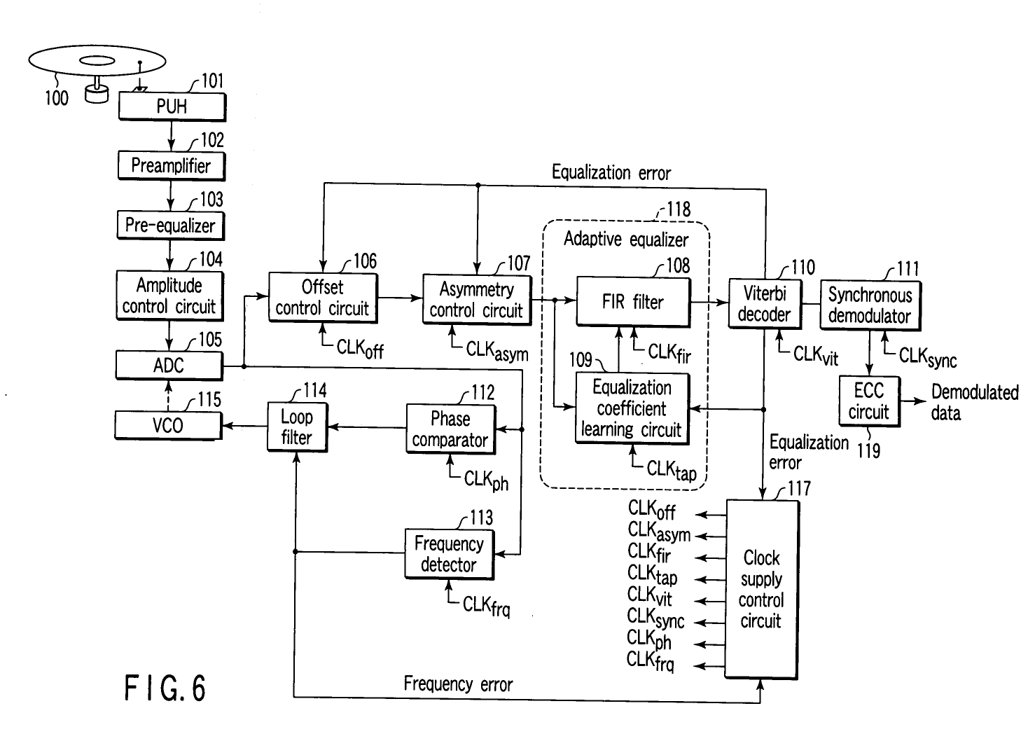

Similarly, even in a constitution in which the equalization error value is fed back to perform the offset control or the asymmetry control as in a constitution of FIG. 6, when the supply of the clock is controlled by the designated index value DI, power can be saved. Needless to say, this idea is applied even to a constitution in which there is used another waveform shaping circuit to feed back the equalization error value.

Here, the equalization error square average value has been described as the evaluation index obtained by processing the equalization error value, but the evaluation index value is not limited to this value. A simulated bit error rate (SbER) or a partial response signal to noise ratio (PRSNR) defined by HD DVD specifications, or a sequence amplitude margin (SAM) which is a general evaluation index in the PRML signal processing system is also an evaluation index value obtained by processing the equalization error value. These values may be used (with the proviso that conditions of the clock supply need to be reversed as in the PRSNR, because the quality level of this signal becomes high as the evaluation index value increases).

A level of stability of a steady reproduction state is judged, and the supply of the clock to the frequency detector is controlled based on the level.

The present invention will be described in accordance with a third embodiment. In the third embodiment, there is further added a steady reproduction judgment unit which judges a level of stability of a steady reproduction state (a PLL is locked, and an adaptive equalizing operation is normal). In a case where an output of the unit becomes larger than a designated level (the output is more stably read), supply of a clock to a frequency detector is stopped. If the output is not more than the designated level, the supply of the clock to the frequency detector is restarted.

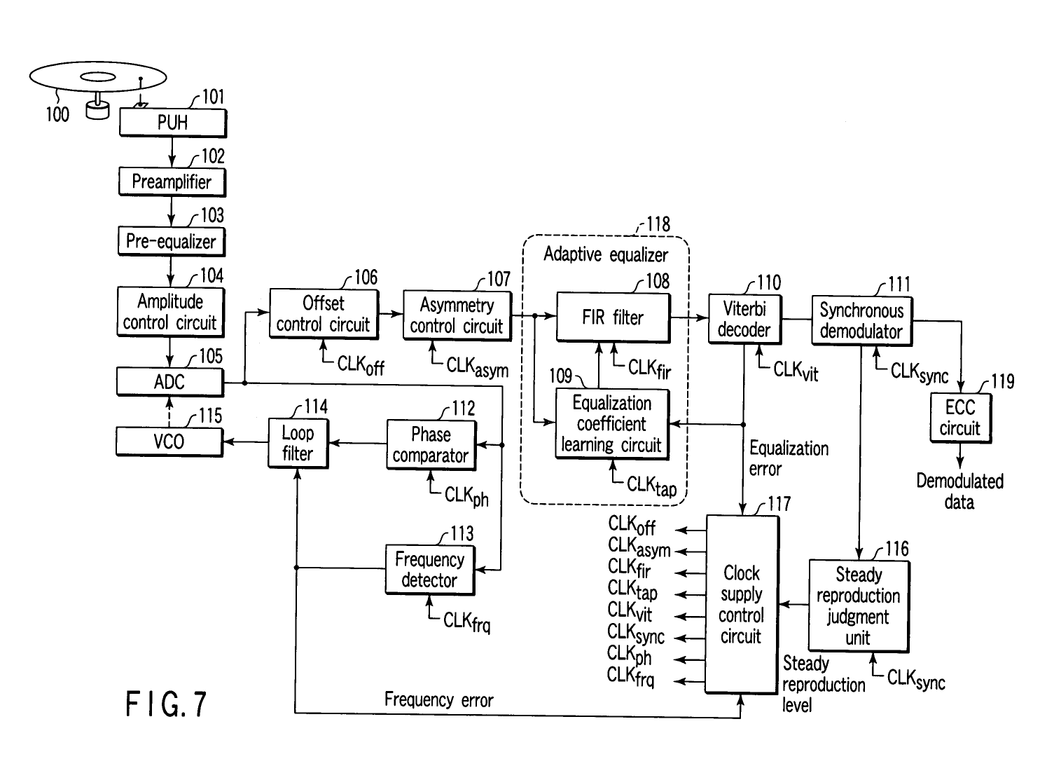

FIG. 7 shows a constitution diagram of the third embodiment.

In FIG. 7, there is further added a steady reproduction judgment unit 116 which judges the level of the stability of the steady reproduction state. The steady reproduction judgment unit 116 judges the level of the stability from a sync detection result of a synchronous demodulator 111.

An operation of this steady reproduction judgment unit 116 will be described hereinafter. In an only case where it is detected that sync codes input every 1116 bits completely agree with one another, a completely sync detection pulse SD is generated, and transmitted to the steady reproduction judgment unit 116. The steady reproduction judgment unit 116 checks continuity of this completely sync detection pulse SD. When the pulses continue successively, it is judged that a reproducing operation is steady, and a judgment level is raised.

In a case where a signal quality level is deteriorated halfway, the sync codes do not completely agree with one another, the continuity of the completely sync detection pulse SD is lost, and the stability level drops. Even in a case where the reproduction frequency deviates, the code is interrupted at an interval of 1116 bits. Therefore, the stability level drops. The level of the stability judged by the steady reproduction judgment unit 116 in this manner is transmitted to a clock supply control circuit 117.

Next, the clock supply control circuit 117 compares this stability level with a designated level. When the stability level becomes larger than the designated level, supply of a clock CLKfrq to a frequency detector 113 is stopped. That is, during the steady operation, the frequency does not have to be controlled. In consequence, power can be saved. In a case where the stability level becomes smaller than the designated level, the reproduction frequency might deviate as described above. Therefore, the supply of the clock CLKfrq to the frequency detector is started.

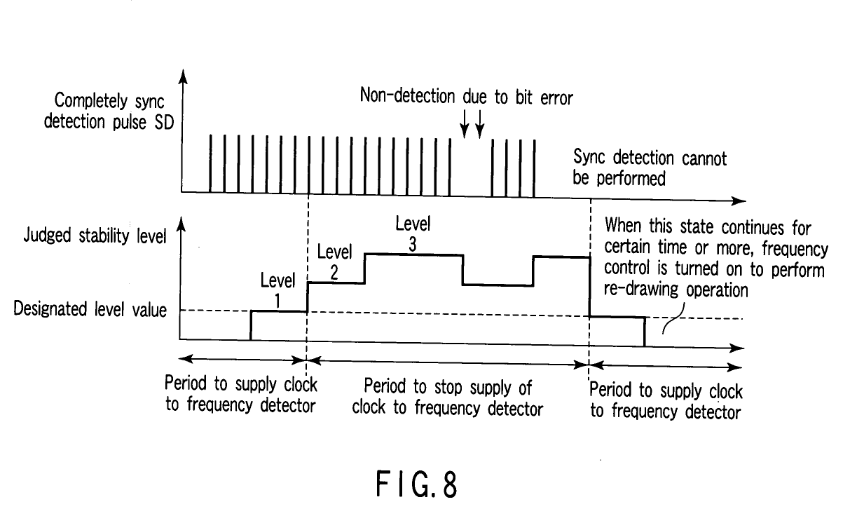

A behavior of this operation will be described with reference to FIG. 8.

FIG. 8 shows an example of the steady reproduction judgment unit 116 in which the level rises by one step in a case where there are four consecutive completely sync detection pulses SD, and a maximum level is set to level 3. There is shown a case where a designated level value is set to level 1. Therefore, in FIG. 8, the level rises to level 2 at a time when eight consecutive completely sync detection pulses SDs are detected, and the supply of the clock to the frequency detector 113 is stopped. After the supply of the clock is stopped, the detection of the completely sync detection pulse SD continues. Therefore, the level rises to the level 3, and the steady reproducing operation is continued.

It is assumed that the level is set to be lowered by one level in a case where non-detection of the completely sync detection pulse SD occurs even once. In this case, when a bit error is generated owing to deterioration of the signal quality level, and any completely sync detection pulse SD cannot be detected, the stability level drops from the level 3 to the level 2.

In FIG. 8, any completely sync detection pulse SD is not detected even in the next sync position. However, in a case where conditions on which the level drops to the level 1 are set to conditions that non-detection continues four times, the level remains at the level 2. Thereafter, if four consecutive codes are detected, the level again rises to the level 3.

In FIG. 8, the last period indicates an example in which the non-detection continues successively owing to deviation of reproduction frequency or phase synchronization. Here, the period is set so that even in a case where the level remains at the level 3, when four or more consecutive codes are not continuously detected, the level drops to the level 1. In this case, the stability level drops to the level 1 at once. Since the designated level is the level 1 or less, the clock supply control circuit 117 again supplies the clock to the frequency detector 113, and starts a preparation for frequency control. In a case where further codes are not continuously detected, the level drops to level 0, and this state continues for a certain time or more, the frequency control is started, and a re-drawing operation is performed to reset a system.

As described above, in the present invention, in a case where the supply of the clock is controlled in an adaptive manner in accordance with an operating situation of the PRML signal processing in which a large power consumption raises a problem, it is possible to save power.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk drive which decodes data recorded in an optical disk by use of PRML signal processing, the drive comprising:
an optical pickup which irradiates the optical disk with laser light and which detects reflected light from the optical disk to supply a reproduction signal;
an analog to digital converter which converts, into a digital value, a level of the reproduction signal supplied from the optical pickup;
a voltage control oscillator which supplies a clock for conversion to the analog to digital converter;
a frequency detector which detects a frequency error between a frequency of the reproduction signal supplied from the analog to digital converter and a frequency of the clock for conversion;
a phase comparator which detects a phase error between an ideal sampling phase of the reproduction signal supplied from the analog to digital converter and a phase of the clock for conversion;
a loop filter which controls an oscillation frequency of the voltage control oscillator based on the frequency error from the frequency detector and the phase error from the phase comparator;
an adaptive equalizer which equalizes a waveform of the reproduction signal supplied from the analog to digital converter to obtain a waveform indicating a desired PR characteristic;
a maximum likelihood decoder which converts, into reproduction data, a waveform equalization signal supplied from the adaptive equalizer by maximum likelihood decoding; and
a clock supply control circuit which stops supply of a clock to at least the phase comparator, the adaptive equalizer and the maximum likelihood decoder, in a case where the frequency error is larger than a designated error.

2. The optical disk drive according to claim 1, further comprising:
a synchronous demodulator which detects a synchronous code in the reproduction data decoded by the maximum likelihood decoder and which demodulates the reproduction data; and
an error correction circuit which corrects an error of the demodulated data supplied from the synchronous demodulator,
the clock supply control circuit stopping the supply of the clock to the synchronous demodulator and the error correction circuit in addition to the phase comparator, the adaptive equalizer and the maximum likelihood decoder, in a case where the frequency error is larger than the designated error.

3. The optical disk drive according to claim 1, further comprising:
a plurality of waveform shaping circuits which subject an output signal of the analog to digital converter to waveform shaping for different purposes,
the clock supply control circuit stopping the supply of the clock to the waveform shaping circuit which is not included in a signal path from the analog to digital converter to the frequency detector among the plurality of waveform shaping circuits, in a case where the frequency error is larger than the designated error.

4. An optical disk drive which decodes data recorded in an optical disk by use of PRML signal processing, the drive comprising:
an optical pickup which irradiates the optical disk with laser light and which detects reflected light from the optical disk to supply a reproduction signal;
an FIR filter which equalizes a waveform of the reproduction signal supplied from the optical pickup;
a maximum likelihood decoder which converts, into reproduction data, an output signal of the FIR filter by maximum likelihood decoding;
an equalization error generation circuit which generates, as an equalization error, a difference between an ideal reproduction signal generated by the maximum likelihood decoder and the output signal of the FIR filter;
an equalization coefficient control circuit which controls an equalization coefficient of the FIR filter based on the equalization error generated by the equalization error generation circuit; and
a clock supply control circuit which stops supply of a clock to the equalization coefficient control circuit, in a case where an evaluation index value generated by processing the equalization error generated by the equalization error generation circuit is smaller than a designated index value, and which restarts the supply of the clock to the equalization coefficient control circuit, in a case where the evaluation index value is larger than the designated index value.

5. The optical disk drive according to claim 3, further comprising:
an offset control circuit which controls an offset of the reproduction signal supplied from the optical pickup by use of the equalization error generated by the equalization error generation circuit; and
an asymmetry control circuit which controls asymmetry of the reproduction signal supplied from the optical pickup by use of the equalization error,
the clock supply control circuit stopping the supply of the clock to the offset control circuit and the asymmetry control circuit, in a case where the evaluation index value is smaller than the designated index value,
the clock supply control circuit restarting the supply of the clock to the offset control circuit and the asymmetry control circuit, in a case where the evaluation index value is larger than the designated index value.

6. An optical disk drive which decodes data recorded in an optical disk by use of PRML signal processing, the drive comprising:
an optical pickup which irradiates the optical disk with laser light and which detects reflected light from the optical disk to supply a reproduction signal;
an analog to digital converter which converts, into a digital value, a level of the reproduction signal supplied from the optical pickup;
a voltage control oscillator to supply a clock for conversion to the analog to digital converter;
a frequency detector which detects a frequency error between a frequency of the reproduction signal supplied from the analog to digital converter and a frequency of the clock for conversion;
a phase comparator which detects a phase error between an ideal sampling phase of the reproduction signal supplied from the analog to digital converter and a phase of the clock for conversion;
a loop filter which controls an oscillation frequency of the voltage control oscillator based on the frequency error from the frequency detector and the phase error from the phase comparator;
an adaptive equalizer which is controlled in an adaptive manner by use of a signal decoded by the PRML signal processing and which equalizes a waveform of the reproduction signal supplied from the analog to digital converter;
a steady reproduction judgment unit which judges an operation stability of a reproduction state of the optical disk drive and which supplies a level of the judged stability; and
a clock supply control circuit which stops supply of a clock to the frequency detector, in a case where the stability level supplied from the steady reproduction judgment unit becomes larger than a designated level, and which restarts the supply of the clock to the frequency detector, in a case where the stability level is not more than the designated level.
